(19) United States
(12) Patent Application Publication
(10) Pub. No.: US 2006/0293192 A1
(43) Pub. Date: Dec. 28, 2006

(54) Lubricants for drilling fluids and methods for using the same

(75) Inventors: Frank P. Lochel, Simpsonville, SC (US); Jeremy Nalley, Honea Path, SC (US)

Correspondence Address: DORITY & MANNING, P.A., POST OFFICE BOX 1449, GREENVILLE, SC, 29602-1449, US

(73) Assignee: Rutgers Organics

(21) Appl. No.: 11/158,890

(22) Filed: Jun. 22, 2005

(51) Int. Cl. C09K 8/02

(52) U.S. Cl. 507/136

(57) ABSTRACT

A lubricant additive to a drilling fluid, or drilling mud, is generally disclosed. The lubricant additive is a diester of an alkyleneoxide polymer. The lubricant additive can be added to water, silicate, and oil based drilling fluids. Also, a process for drilling a well or borehole is generally disclosed wherein the lubricant additive is injected into the drillpipe string of the drilling apparatus.

### BACKGROUND OF THE INVENTION

Drilling boreholes or wells into the earth, be it petroleum wells, water wells, or other types of boreholes or wells, typically requires the use of a drill bit attached to the end of a drillpipe string. The drill bit can be toothed and rotated to drill into rock, clay, or other substances contained within the earth. A surface installation, or drilling rig, generally drives the drillpipe string and drill bit. In order to facilitate the drilling process, a drilling fluid or mud is utilized to perform many necessary functions and to facilitate the drilling process.

Typically, the drilling fluid is circulated through the borehole or well during the drilling process. First, the drilling fluid begins at the drilling rig and is injected or inserted into the drillpipe string at the surface installation or drilling rig. The drilling fluid then flows down the borehole through the interior of the drillpipe string and to the drill bit, supporting the integrity of the drillpipe string while lubricating and cooling the inside of the drillpipe string as it flows. The drilling fluid can then clean, lubricate, and cool the drill bit as it is flows out of the bottom of the drillpipe string or drill bit.

The drilling fluid flows back up the borehole towards the surface in the space between the drillpipe string and the borehole wall, carrying drill cuttings and debris to the surface while lubricating the outside of the drillpipe string and supporting the borehole walls. At the surface, the drilling fluid can then be recovered and recycled.

Throughout this process, the drilling fluid must be able to withstand significant pressure and temperature changes, while still performing its intended function. For example, when injected into the drillpipe string at the drilling rig, the temperature and pressure can be that of the surrounding atmosphere, which can vary depending on the geographical location of the rig. On the other hand, the temperature and pressure at the bottom of the borehole or well can be extreme, possibly reaching temperatures of about 400° F. or more and pressures of about 30,000 psi or more.

Also, directional changes of the borehole can create additional stresses on the drillpipe string, including added friction. At these extreme conditions, heat, pressure, and friction caused by the movement of the drillpipe string and the drill bit can wear on the drilling equipment causing damage to the equipment and slowing the drilling process.

As such, a need exists for a lubricant additive to a drilling fluid, capable of withstanding extreme operating conditions typically encountered during the drilling process, that can better lubricate the drillpipe string, drill bit, and other parts of the drilling apparatus. A need also exists for a lubricant additive to a drilling fluid that lowers the coefficient of friction of the moving parts at these extreme conditions.

### SUMMARY OF THE INVENTION

Objects and advantages of the invention will be set forth in part in the following description, or may be obvious from the description, or may be learned through practice of the invention.

One embodiment of the present disclosure is generally directed toward a lubricating composition for use in a borehole. The lubricating composition comprises a drilling fluid and a diester of an alkyleneoxide polymer. In one embodiment, the alkyleneoxide polymer can be esterified with a fatty acid being from about 8 to about 26 carbons in length. For example, the alkyleneoxide polymer can be esterified with oleic acid.

In one embodiment, the alkyleneoxide polymer can comprise a homopolymer. For example, the homopolymer can comprise either a polyethylene glycol or a polypropylene glycol, each having at least 1 monomer.

In another embodiment, the alkyleneoxide polymer can comprise a block copolymer of ethylene oxide/propylene oxide. For example, the block copolymer of ethylene oxide/propylene oxide can comprise from about 5% to about 20% ethylene oxide by weight. The block copolymer of ethylene oxide/propylene oxide can be capped by ethylene oxide. In one embodiment, the diester of an alkyleneoxide polymer can comprise a dioleate of a block co-polymer of ethylene oxide/propylene oxide.

The drilling fluid can be a water based drilling fluid, an oil based drilling fluid, or a silicate based drilling fluid. The lubricating composition can have a pH value of greater than about 7, such as greater than about 9. For example, a silicate based or an oil based drilling fluid can have a pH value greater than about 13.

The diester of the alkyleneoxide polymer can be present in an amount that does not destabilize the drilling fluid. For example, the diester can be present in an amount from about 0.1% to about 8% by weight, such as from about 0.5% to about 6% by weight. For example, in one embodiment, the the alkyleneoxide polymer can be present in an amount from about 2% to about 4% by weight.

In another embodiment, the present disclosure is generally directed toward a method of drilling a borehole or well. The method comprises the steps of providing a drill bit, connecting a drillpipe string to the drill bit, and injecting a drilling fluid into the drillpipe string. The drilling fluid flows through the drillpipe string to the drill bit. The drilling fluid comprises a diester of an alkyleneoxide polymer. For example, the alkyleneoxide polymer can be a block copolymer of ethylene oxide/propylene oxide. In one embodiment, the alkyleneoxide polymer can be esterified with oleic acid.

Additional objects and advantages of the present subject matter are set forth in, or will be apparent to, those of ordinary skill in the art from the detailed description herein. Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly stated in the detailed description). Those of ordinary skill in the art will better appreciate the features and aspects of such embodiments, and others, upon review of the remainder of the specification.

### DETAILED DESCRIPTION OF THE INVENTION

The present application generally provides for a lubricant additive to a drilling fluid and methods for using the same. In order to fully understand the advantages of the present disclosure, various embodiments will be explained in greater detail as exemplary embodiments of the present invention. Each example is provided by way of explanation of the invention, and not meant as a limitation of the invention. For example, features described as part of one embodiment may be used with another embodiment to yield still a further embodiment. In fact, it will be apparent to those skilled in the art that various modifications and variations can be made in the present invention without departing from the scope or spirit of the invention.

According to the present disclosure, a lubricant additive is included in a drilling fluid, sometimes referred to as a drilling mud. The lubricating additive can allow the drilling fluid to better lubricate the drill bit and drillpipe string. Also, the lubricant additive can withstand the extreme conditions of the drilling process, especially at directional changes in the borehole and at the drill bit. For example, the lubricant additive can remain stable and functioning at the high temperatures and pressures typically present at the drill bit during the drilling process.

Also, the lubricant additive does not prevent the drilling fluid from performing other functions in the drilling process. In fact, the lubricant additive can actually help perform some of the other functions of the drilling fluid.

Some of the drilling fluid's main functions include cleaning the drill bit, lubricating the drill bit and drillpipe string, and carrying the drill cuttings and other debris created by the drilling process toward the surface. Other functions performed by the drilling fluid can include cooling the drill bit and drillpipe string, maintaining the integrity of the borehole's walls, helping prevent cave-ins and/or blow-outs, and supporting the drillpipe string and drill bit, The drilling fluid's function can also change as the drilling process proceeds. For example, a “drill-in” fluid, used when drilling the borehole to the producing formation, may have to be able to perform different functions as a “completion fluid,” used to continue the drilling operation after the well reaches the desired depth or producing formation.

In one embodiment, the lubricant additive of the present disclosure is a diester of an alkyleneoxide polymer that is added to or incorporated into the drilling fluid. The alkyleneoxide polymer can be a homopolymer or a copolymer, such as a random copolymer, an alternating copolymer, a block copolymer, or the like.

Furthermore, the alkyleneoxide polymer can comprise any alkyleneoxide monomer, including, but not limited to, ethylene oxide, propylene oxide, butylenes oxide, and combinations thereof. The alkyleneoxide monomers can form a homopolymer or a copolymer.

For example, in one embodiment, the alkyleneoxide polymer can be a polypropylene glycol (also known as polypropylene oxide), which is a polymer of at least one propylene oxide monomer. A homopolymer of polypropylene glycol generally can be represented by the following formula: 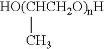
wherein n is an integer of 1 or greater. For example, in one embodiment, the polypropylene glycol according to the present disclosure can have a molecular weight of up to about 10,000, such as from about 76 to about 5,000. In one particular embodiment, the polypropylene glycol can have a molecular weight of about 76, which represents the monomer of propylene glycol (wherein n is 1).

In another embodiment, the alkyleneoxide polymer can be a polyethylene glycol (also known as polyethylene oxide), which is a polymer of at least one ethylene oxide monomer. A homopolymer of polyethylene glycol generally can be represented by the following formula:
HO(CH₂CH₂O)ₙH
wherein n is an integer of 1 or greater. For example, in one embodiment, the polyethylene glycol according to the present disclosure can have a molecular weight of up to about 10,000, such as from about 62 to about 5,000. In one particular embodiment, the polyethylene glycol can have a molecular weight of about 106, which represents diethylene glycol (wherein n is 2).

In another embodiment, the lubricant additive can be a diester of a copolymer of at least two different alkyleneoxide monomers. For instance, the copolymer of at least two different alkyleneoxide monomers can be an alternating copolymer, a random copolymer, a block copolymer, or the like.

For instance, in one particular embodiment, a diester of a block copolymer of ethylene oxide/propylene oxide can be incorporated into the drilling fluid. For example, the block copolymer of ethylene oxide/propylene oxide can have from about 1% to about 25% ethylene oxide, such as about 5% to about 20% ethylene oxide. For example, in one embodiment, the block copolymer of ethylene oxide/propylene oxide can be about 10% ethylene oxide. In another embodiment, the block copolymer of ethylene oxide/propylene oxide can be about 20% ethylene oxide.

In one embodiment, the ethylene oxide/propylene oxide block copolymer can be capped at both ends of the polymer by either the ethylene oxide block or the propylene oxide block. For example, the ethylene oxide capped block co-polymer of ethylene oxide/propylene oxide can have the following formula: 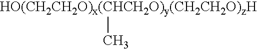
wherein x, y, and z are each independently an integer 1 or greater.

Alternatively, in another embodiment, the ethylene oxide/propylene oxide block copolymer can be capped at both ends of the polymer by the propylene oxide block. For instance, the propylene oxide capped block co-polymer of ethylene oxide/propylene oxide can have the following formula: 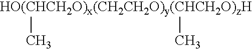
wherein x, y and z are each independently an integer 1 or greater.

However, other ethylene oxide capped and propylene oxide capped block copolymers of ethylene oxide/propylene oxide are also included within the scope of the present disclosure. For example, the block copolymers can be the polymers generally described in U.S. Pat. No. 5,298,120, which is incorporated herein in its entirety by reference.

For example, in one embodiment, the block copolymer of ethylene oxide/propylene oxide can be the polymer sold under the trade name Chemax BP 261 by Chemax Division of Rutgers Organics Corp., located at 30 Old Augusta Road, Piedmont, S.C. Chemax BP 261 is ethylene oxide capped at both ends of the block copolymer, contains about 10% ethylene oxide and about 90% propylene oxide, and has an average molecular weight of about 2000.

Suitable block copolymers are also sold by other companies. For example, BASF, Corp. of Florham Park, N.J. sells a line of block copolymers under the name Pluronic. For instance, the block copolymer can be the polymer sold under the trade name Pluronic L62, which is believed to be a block copolymer of ethylene oxide/propylene oxide having an average molecular weight of about 2500. Pluronic L62 is believed to be ethylene oxide capped at both ends and contain about 80% propylene oxide and about 20% ethylene oxide.

Another block polymer within the scope of this disclosure is Pluronic L121, which is believed to be a block copolymer of ethylene oxide/propylene oxide having an average molecular weight of about 4400. Pluronic L121 is believed to be ethylene oxide capped at both ends and contain about 10% ethylene oxide.

Yet another block polymer within the scope of this disclosure is Pluronic L122, which is believed to be a block copolymer of ethylene oxide/propylene oxide having an average molecular weight of about 5000. Pluronic L122 is believed to be ethylene oxide capped at both ends and contain about 20% ethylene oxide.

The alkyleneoxide polymer can have an average molecular weight of up to about 10,000. For example, the block co-polymer of ethylene oxide/propylene oxide can have an average molecular weight ranging from about 1000 to about 6000, such as from about 2000 to about 5000. In other exemplary embodiments, the alkyleneoxide polymer can have as few as 2 monomer units, or even as few as 1 monomer unit.

According to the present disclosure, the alkyleneoxide polymer is subjected to esterification to form a diester of the alkyleneoxide polymer. The process of esterification is well known and generally can be described as the condensation (ie: a reaction that produces water) of an alcohol with a carboxylic acid. According to the present disclosure, the alcohol group subjected to esterification is each terminal alcohol of the alkyleneoxide polymer.

The alkyleneoxide polymer can be esterified by any method and with any suitable carboxylic acid or combination of carboxylic acids. In one embodiment, the alkyleneoxide polymer can be esterified with a fatty acid. Fatty acids can be represented by the following formula: 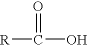
where R represents a hydrocarbon chain. The entire hydrocarbon chain of the fatty acid is the number of carbons in the R group plus one (the terminal carbon) and can be can be of any length, such as comprising from about 4 to about 26 carbons, for example from about 12 to about 22 carbons. Alternatively, in other embodiments, the hydrocarbon chain can comprise from about 18 carbons to about 26 carbons. For instance, in one particular embodiment, the fatty acid can have a hydrocarbon chain comprising 18 carbons. The hydrocarbon chain can be saturated, monounsaturated, or polyunsaturated.

Many fatty acids have common names, relating to their hydrocarbon chain, that describe the molecule. Examples of saturated fatty acids that can be used to esterify the alkyleneoxide polymer include, but are not limited to, lauric acid (12:0), tridecic acid (13:0), myristic acid (14:0), pentadecic acid (15:0), palmitic acid (16:0), heptadecic acid (17:0), stearic acid (18:0), arachidic acid (20:0), and behenic acid (22:0).

Examples of unsaturated fatty acids that can be used to esterify the alkyleneoxide polymer include, but are not limited to, palmitoleic acid (16:1^{Δ9}), oleic acid (18:1^{Δ9}), linoleic acid (18,2^{Δ9,12}), conjugated linoleic acid (18:2^{Δ9,11}), linolenic acid (18:3^{Δ9,12,15}), γ-linolenic acid (18:3^{Δ6,9,12}), eicosenoic acid (20:1), eicosadienoic acid (20:2^{Δ11,14}), arachidonic acid (20:4^{Δ5,8,11,14}), cetoleic acid (22:1^{Δ11}), and erucic acid (22:1^{Δ13}).

The alkyleneoxide polymer can be esterfied with any fatty acid or combination of fatty acids. In one particular embodiment, oleic acid can be used to diesterify the alkyleneoxide polymer. For example, the block copolymer of ethylene oxide/propylene oxide described above can be diesterified with oleic acid. For instance, in one particular embodiment, the lubricant additive can be a oleic acid diester of a block copolymer of ethylene oxide/propylene oxide comprising about 10% propylene oxide and having a molecular weight of about 2000.

A diester of the alkyleneoxide polymer results when both terminal ends of the alkyleneoxide polymer have been esterified by a carboxylic acid. As such, to form the diester of the alkyleneoxide polymer, the carboxylic acid is present in about a 2:1 molar ratio of the alkyleneoxide polymer. However, it is preferred that excess carboxylic acid not be present after the reaction completes, especially if the reaction mixture is to be added directly to the drilling fluid. For example, in one embodiment, the carboxylic acid is present in about a 2:1.1 molar ratio of the alkyleneoxide polymer to form the diester. In this embodiment, there may be some monoesters present in the final reaction mixture, which does not substantially affect the overall performance of the final product. Preferably, the esterification process continues until the acid value of the ester is about 5 mg KOH/g sample or less.

The esterification process can be in the presence of a catalyst, such as an acid, or without a catalyst. Generally, the mixing vessel is agitated under a nitrogen blanket during heating in the range of about 160° C. to about 220° C. Of course, other methods of esterification may be employed for producing the composition of the present disclosure, and the description herein is not limited to any particular esterification method.

There are several types of drilling fluids that can be used depending on the drilling conditions encountered, including water based fluids, silicate based fluids, and oil based fluids. These fluids can typically be in the form of solutions, dispersions, or suspensions. Typically drilling fluids are highly saturated, such as a highly saturated solution or suspension.

Water-based fluids or muds are used most frequently. The water base may be either fresh water or salt water. Typically, water based fluids can be highly saturated brine solutions, dispersions, or suspensions with a density of greater than about 9 lbs/gal, such as from about 12 lbs/gal to about 17 lbs/gal. However, the drilling fluid can be less saturated, such as sea water.

Any suitable salts, not necessarily limited to metal salts, can be included in the drilling fluids, including, but not limited to, sodium chloride, calcium chloride, calcium bromide, or zinc bromide. Suitable cations that can be present include, but are not limited to, calcium, magnesium, sodium, potassium, cesium, zinc, aluminum, and lithium. Suitable anions that can be present include, but are not limited to, chlorides, bromides, fermates, acetates, and nitrates.

Silicate fluids can also be used as a drilling fluid. Silicate fluids can contain, for example, potassium silicate. For instance, the potassium silicate can be present in the silicate based drilling fluid in an amount of about 12% by weight potassium silicate.

Oil-based muds can be made out of various natural and synthetic materials. The oil and gas extraction industry has developed many oleaginous (oil-like) base materials from which to formulate high-performance drilling fluids. A general class of these fluids is called synthetic materials, such as the vegetable esters, poly alpha olefins, internal olefins, linear alpha olefins, synthetic paraffins, ethers, and linear alkylbenzenes, among others.

Air and foam fluids may also be used in drilling wells. These fluids are typically less dense than other types of drilling fluids.

Drilling fluids or muds can also include other types of additives within the scope of the present disclosure. For example, weighting materials, such as barite (barium sulfate), may be used to increase the density of the mud in order to equilibrate the pressure between the borehole and formation when drilling through particularly pressurized zones. Also, hematite (Fe₂O₃) can be used as a weighting agent, especially in oil-based fluids or muds.

Corrosion inhibitors, such as iron oxide, aluminum bisulfate, zinc carbonate, and zinc chromate, can be added to the drilling fluid and are helpful in protecting pipes and other metallic components from acidic compounds encountered in the drilling process. Dispersants, such as iron lignosulfonates, can be included in the drilling fluid to help break up solid clusters into small particles so they can be carried by the fluid. Flocculants, such as acrylic polymers, can also be included in the drilling fluid to cause suspended particles to group together so they can be removed from the fluid at the surface. Surfactants, like fatty acids and soaps, can be incorporated into the drilling fluid to defoam and emulsify the mud. Biocides, such as organic amines, chlorophenols, or formaldehydes, can be present to kill bacteria and help reduce the souring of drilling mud. Fluid loss reducers including, but not limited to, starch and organic polymers can be included to help limit the loss of drilling mud to under-pressurized or high-permeability formations.

Other additives can also be included into the drilling fluid or mud, such as viscosifiers, bridging agents, pH modifiers or stabilizers, and other lubricants and additives.

Many of the typical drilling fluids, especially the water based and silica based fluids, can be highly saturated. Because of the high saturation of these fluids, the fluids have been resistant to the addition of any lubricating compositions without the destabilization of the solution or suspension. However, surprisingly, the present inventors have found that the lubricating compositions of the present invention can be added to the drilling fluids without destabilizing the solution or suspension, either water based, silica based, or oil based.

As such, the lubricating composition can be present in the drilling fluid in any amount such that the fluid does not destabilize. For example, in some embodiments, the lubricating composition of the present disclosure can be present in an amount from about 0.1% to about 8% by weight, such as from about 0.5% to about 6% by weight. For example, in some particular embodiments, the lubricating composition can be present in an amount from about 2% to about 4% by weight.

Water based drilling fluids typically have a pH value of greater than about 7, such as greater than about 9 or greater than about 10. For oil based and silica based drilling fluids, the pH value can be even higher, such as greater than about 12, or greater than about 13.

Surprisingly, the present inventors have discovered that the diester of an alkyleneoxide polymer can unexpectantly withstand these higher pH values without substantially hydrolyzing. Typically one skilled in the art would expect that an ester would hydrolyze to the original alcohol and carboxylic acid in a solution with a pH value greater than 7, and especially in a solution with a pH greater than about 9. However, the present inventors have discovered that mixing or blending a diester of an alkyleneoxide polymer with a drilling fluid having a pH of greater than about 9, or even greater than about 12, does not substantially hydrolyze the diester polymer, especially when the drilling fluid is subjected to the extreme conditions found in the drilling process.

### EXAMPLES

All of the following exemplary diesters of an alkyleneoxide polymer were made according to the following esterification process: 2 moles of the selected fatty acid was combined with 1.1 moles of the diol (the base polymer). The reagents were blended with heat agitation to about 160° C. to about 220° C. The reactions were continued until the acid value of the resultant ester was about 5 mg KOH/g sample or less.

The exemplary alkyleneoxide polymers and the corresponding carboxylic acids used to form the resulting diesters tested in the examples are shown below:

Exemplary Diesters of Alkyleneoxide Polymers

| | | Resulting Diester |
|---|---|---|
| Base Polymer Name | Carboxylic Acid | Abbreviation |
| Chemax BP 261 | Oleic Acid | BP261 DO |
| Chemax BP 261 | Eurycic Acid | BP261 DE |
| Chemax BP 261 | C₈-C₁₀ Fatty Acids | BP261 DCC |
| Chemax BP 261 | Stearic Acid | BP261 DS |
| Chemax BP 261 | Lauric Acid | BP261 DL |
| Pluronics L62 | Oleic Acid | L62 DO |
| Pluronics L121 | Oleic Acid | L121 DO |
| Pluronics L121 | C₈-C₁₀ Fatty Acids | L121 DCC |
| Pluronics L122 | Oleic Acid | L122 DO |
| Pluronics L122 | C₈-C₁₀ Fatty Acids | L122 DCC |
| Polypropylene glycol | Oleic Acid | PG DO |
| (n = 1) | | |
| Polyethylene glycol | Oleic Acid | DEG DO |
| (n = 2) | | |

### Example 1

After the esterification of each of the above base polymers with the respective carboxylic acid, each resulting diester was blended or mixed with a water based drilling mud sold under the trade name Generic #7 by Newpark Drilling Fluids, LLC of Houston Tex. (referred to as “NP G#7”).

Each diester was added at 4% by weight of the drilling fluid to create separate samples to be tested. The torque (measured in inch-lbs) required to rotate the pin at increasing reference loads was measured for each sample using a Falex Friction and Wear Test Machine, model Pin and V-Block, available from the Falex Corp. of Aurora, Ill. The results of torque tests for each sample are shown in Table 1.

Then, the coefficient of friction for each tested sample was calculated according to the formula: Coefficient of Friction=2.9726*torque/reference load.

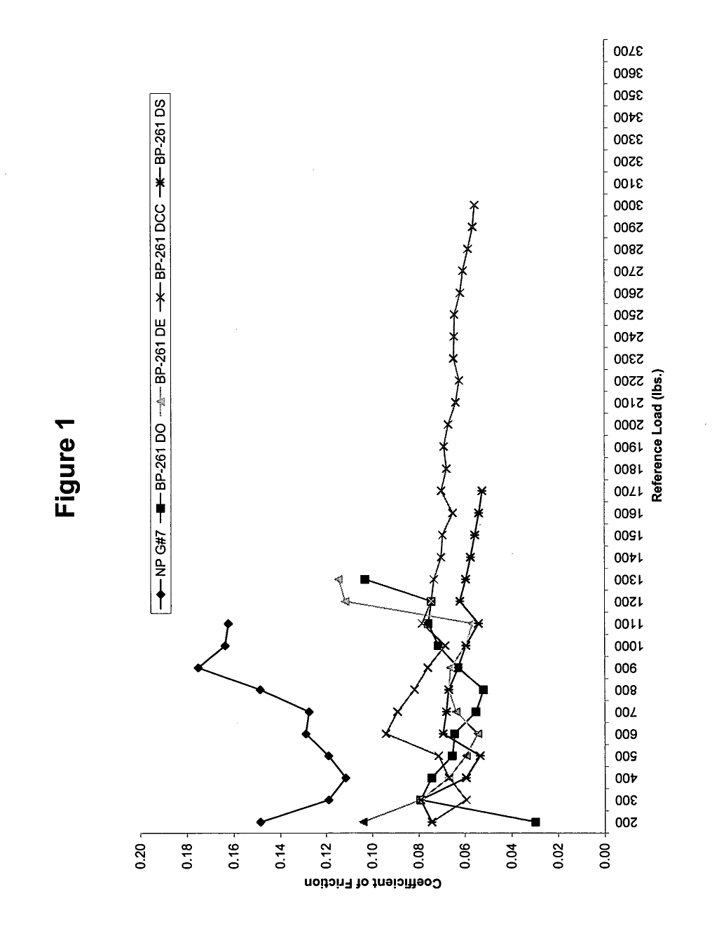

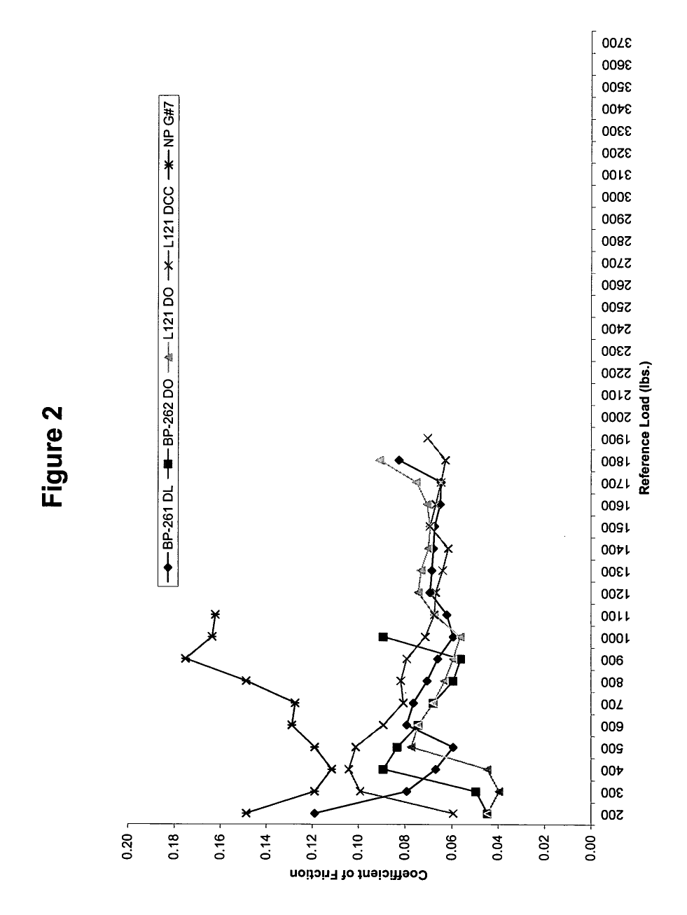

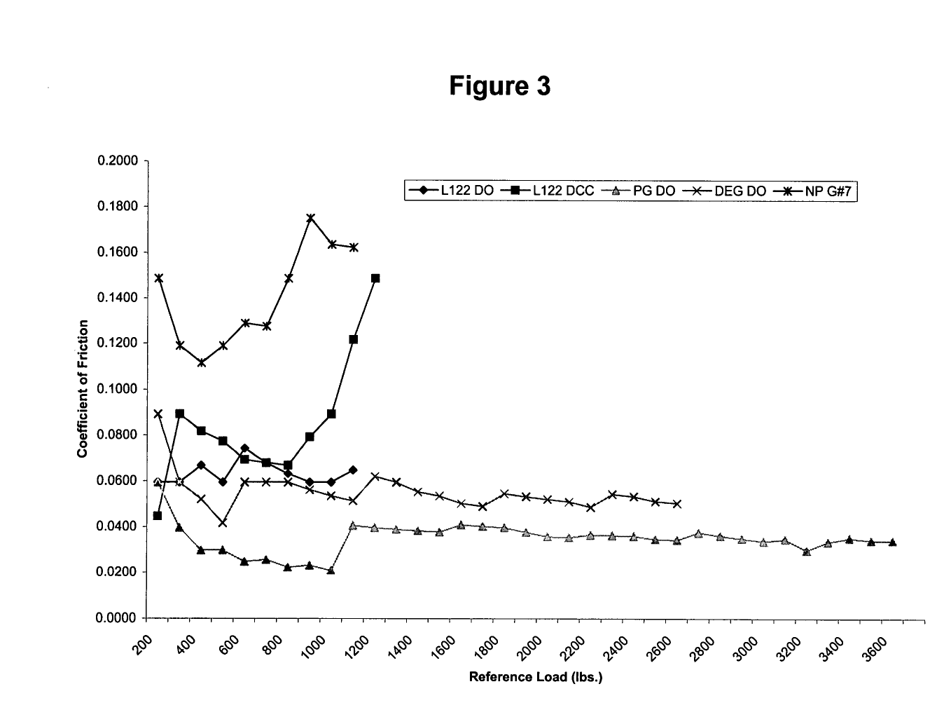

The calculated coefficient of friction for each sample at the increasing reference loads are shown in Table 2. Also, the calculated coefficient of friction is respectively depicted in and FIGS. 1, 2, and 3. FIGS. 1, 2 and 3 show that each of the samples containing a diester of an alkyleneoxide polymer exhibits lower coefficients of friction at higher loads than the water based drilling fluid (New Park Generic #7) without any lubricating composition present.

TABLE 1
Raw Torque Data for each sample added to NP G#7 at about 4% by weight.

| Reference | NP G#7 | BP-261 DO | BP-261 DE | BP-261 DCC | BP-261 DS | BP-261 DL | L62 DO |
|---|---|---|---|---|---|---|---|
| Load (lbs.) | (inch-lbs) | (inch-lbs) | (inch-lbs) | (inch-lbs) | (inch-lbs) | (inch-lbs) | (inch-lbs) |
| 200 | 10 | 2 | 7 | 5 | 5 | 8 | 3 |
| 300 | 12 | 8 | 8 | 6 | 8 | 8 | 5 |
| 400 | 15 | 10 | 9 | 9 | 8 | 9 | 12 |
| 500 | 20 | 11 | 10 | 12 | 9 | 10 | 14 |
| 600 | 26 | 13 | 11 | 19 | 14 | 16 | 15 |
| 700 | 30 | 13 | 15 | 21 | 16 | 18 | 16 |
| 800 | 40 | 14 | 18 | 22 | 18 | 19 | 16 |
| 900 | 53 | 19 | 20 | 23 | 19 | 20 | 17 |
| 1000 | 55 | 24 | 20 | 23 | 20 | 20 | 30 |
| 1100 | 60 | 28 | 21 | 29 | 20 | 23 | |
| 1200 | | 30 | 45 | 30 | 25 | 28 | |
| 1300 | | 45 | 50 | 32 | 26 | 30 | |
| 1400 | | | | 33 | 27 | 32 | |
| 1500 | | | | 35 | 28 | 34 | |
| 1600 | | | | 35 | 29 | 35 | |
| 1700 | | | | 40 | 30 | 37 | |
| 1800 | | | | 41 | | 50 | |
| 1900 | | | | 44 | | | |
| 2000 | | | | 45 | | | |
| 2100 | | | | 45 | | | |
| 2200 | | | | 46 | | | |
| 2300 | | | | 50 | | | |
| 2400 | | | | 52 | | | |
| 2500 | | | | 54 | | | |
| 2600 | | | | 54 | | | |
| 2700 | | | | 55 | | | |
| 2800 | | | | 55 | | | |
| 2900 | | | | 55 | | | |
| 3000 | | | | 56 | | | |
| 3100 | | | | | | | |
| 3200 | | | | | | | |
| 3300 | | | | | | | |
| 3400 | | | | | | | |
| 3500 | | | | | | | |

| Reference | L121 DO | L121 DCC | L122 DO | L122 DCC | PG DO | DEG-DO |
|---|---|---|---|---|---|---|
| Load (lbs.) | (inch-lbs) | (inch-lbs) | (inch-lbs) | (inch-lbs) | (inch-lbs) | (inch-lbs) |
| 200 | 3 | 4 | 4 | 3 | 4 | 6 |
| 300 | 4 | 10 | 6 | 9 | 4 | 6 |
| 400 | 6 | 14 | 9 | 11 | 4 | 7 |
| 500 | 13 | 17 | 10 | 13 | 5 | 7 |
| 600 | 15 | 18 | 15 | 14 | 5 | 12 |
| 700 | 16 | 19 | 16 | 16 | 6 | 14 |
| 800 | 17 | 22 | 17 | 18 | 6 | 16 |
| 900 | 18 | 24 | 18 | 24 | 7 | 17 |
| 1000 | 19 | 24 | 20 | 30 | 7 | 18 |
| 1100 | 25 | 25 | 24 | 45 | 15 | 19 |
| 1200 | 30 | 27 | | 60 | 16 | 25 |
| 1300 | 32 | 28 | | | 17 | 26 |
| 1400 | 33 | 29 | | | 18 | 26 |
| 1500 | 35 | 35 | | | 19 | 27 |
| 1600 | 38 | 36 | | | 22 | 27 |
| 1700 | 43 | 37 | | | 23 | 28 |
| 1800 | 55 | 38 | | | 24 | 33 |
| 1900 | | 45 | | | 24 | 34 |
| 2000 | | | | | 24 | 35 |
| 2100 | | | | | 25 | 36 |
| 2200 | | | | | 27 | 36 |
| 2300 | | | | | 28 | 42 |
| 2400 | | | | | 29 | 43 |
| 2500 | | | | | 29 | 43 |
| 2600 | | | | | 30 | 44 |
| 2700 | | | | | 34 | |
| 2800 | | | | | 34 | |
| 2900 | | | | | 34 | |
| 3000 | | | | | 34 | |
| 3100 | | | | | 36 | |
| 3200 | | | | | 32 | |
| 3300 | | | | | 37 | |
| 3400 | | | | | 40 | |
| 3500 | | | | | 40 | |

TABLE 2
Coefficient of Friction for each sample added to NP G#7 at about 4% by weight

| Reference | | BP-261 | BP-261 | BP-261 | BP-261 | BP-261 | BP-262 | | L121 | | | | |
|---|---|---|---|---|---|---|---|---|---|---|---|---|---|
| Load (lbs) | NP G#7 | DO | DE | DCC | DS | DL | D0 | L121 DO | DCC | L122 DO | L122 DCC | PG DO | DEG-DO |
| 200 | 0.1486 | 0.0297 | 0.1040 | 0.0743 | 0.0743 | 0.1189 | 0.0446 | 0.0446 | 0.0595 | 0.0595 | 0.0446 | 0.0595 | 0.0892 |
| 300 | 0.1189 | 0.0793 | 0.0793 | 0.0595 | 0.0793 | 0.0793 | 0.0495 | 0.0396 | 0.0991 | 0.0595 | 0.0892 | 0.0396 | 0.0595 |
| 400 | 0.1115 | 0.0743 | 0.0669 | 0.0669 | 0.0595 | 0.0669 | 0.0892 | 0.0446 | 0.1040 | 0.0669 | 0.0817 | 0.0297 | 0.0520 |
| 500 | 0.1189 | 0.0654 | 0.0595 | 0.0713 | 0.0535 | 0.0595 | 0.0832 | 0.0773 | 0.1011 | 0.0595 | 0.0773 | 0.0297 | 0.0416 |
| 600 | 0.1288 | 0.0644 | 0.0545 | 0.0941 | 0.0694 | 0.0793 | 0.0743 | 0.0743 | 0.0892 | 0.0743 | 0.0694 | 0.0248 | 0.0595 |
| 700 | 0.1274 | 0.0552 | 0.0637 | 0.0892 | 0.0679 | 0.0764 | 0.0679 | 0.0679 | 0.0807 | 0.0679 | 0.0679 | 0.0255 | 0.0595 |
| 800 | 0.1486 | 0.0520 | 0.0669 | 0.0817 | 0.0669 | 0.0706 | 0.0595 | 0.0632 | 0.0817 | 0.0632 | 0.0669 | 0.0223 | 0.0595 |
| 900 | 0.1751 | 0.0628 | 0.0661 | 0.0760 | 0.0628 | 0.0661 | 0.0561 | 0.0595 | 0.0793 | 0.0595 | 0.0793 | 0.0231 | 0.0561 |
| 1000 | 0.1635 | 0.0713 | 0.0595 | 0.0684 | 0.0595 | 0.0595 | 0.0892 | 0.0565 | 0.0713 | 0.0595 | 0.0892 | 0.0208 | 0.0535 |
| 1100 | 0.1621 | 0.0757 | 0.0567 | 0.0784 | 0.0540 | 0.0622 | | 0.0676 | 0.0676 | 0.0649 | 0.1216 | 0.0405 | 0.0513 |
| 1200 | | 0.0743 | 0.1115 | 0.0743 | 0.0619 | 0.0694 | | 0.0743 | 0.0669 | | 0.1486 | 0.0396 | 0.0619 |
| 1300 | | 0.1029 | 0.1143 | 0.0732 | 0.0595 | 0.0686 | | 0.0732 | 0.0640 | | | 0.0389 | 0.0595 |
| 1400 | | | | 0.0701 | 0.0573 | 0.0679 | | 0.0701 | 0.0616 | | | 0.0382 | 0.0552 |
| 1500 | | | | 0.0694 | 0.0555 | 0.0674 | | 0.0694 | 0.0694 | | | 0.0377 | 0.0535 |
| 1600 | | | | 0.0650 | 0.0539 | 0.0650 | | 0.0706 | 0.0669 | | | 0.0409 | 0.0502 |
| 1700 | | | | 0.0699 | 0.0525 | 0.0647 | | 0.0752 | 0.0647 | | | 0.0402 | 0.0490 |
| 1800 | | | | 0.0677 | | 0.0826 | | 0.0908 | 0.0628 | | | 0.0396 | 0.0545 |
| 1900 | | | | 0.0688 | | | | | 0.0704 | | | 0.0375 | 0.0532 |
| 2000 | | | | 0.0669 | | | | | | | | 0.0357 | 0.0520 |
| 2100 | | | | 0.0637 | | | | | | | | 0.0354 | 0.0510 |
| 2200 | | | | 0.0622 | | | | | | | | 0.0365 | 0.0486 |
| 2300 | | | | 0.0646 | | | | | | | | 0.0362 | 0.0543 |
| 2400 | | | | 0.0644 | | | | | | | | 0.0359 | 0.0533 |
| 2500 | | | | 0.0642 | | | | | | | | 0.0345 | 0.0511 |
| 2600 | | | | 0.0617 | | | | | | | | 0.0343 | 0.0503 |
| 2700 | | | | 0.0606 | | | | | | | | 0.0374 | |
| 2800 | | | | 0.0584 | | | | | | | | 0.0361 | |
| 2900 | | | | 0.0564 | | | | | | | | 0.0349 | |
| 3000 | | | | 0.0555 | | | | | | | | 0.0337 | |
| 3100 | | | | | | | | | | | | 0.0345 | |
| 3200 | | | | | | | | | | | | 0.0297 | |
| 3300 | | | | | | | | | | | | 0.0333 | |
| 3400 | | | | | | | | | | | | 0.0350 | |
| 3500 | | | | | | | | | | | | 0.0340 | |
| 3600 | | | | | | | | | | | | 0.0339 | |

### Example 2

BP261 DO was added at different weight percentages to a potassium silicate mud containing 12% potassium silicate provided by Newpark Drilling Fluids, LLC of Houston Tex. BP261 DO was added at 1%, 2%, and 4% weight percentages to the silicate mud. Table 4 shows the raw data of the torque required at certain reference loads for each sample as tested on the Falex Friction and Wear Test Machine.

TABLE 4
Raw Torque Data
(inch-lbs)

| Reference | BP-261 DO | BP-261 DO | BP-261 DO | |
|---|---|---|---|---|
| Load (lbs) | 1% | 2% | 4% | Silicate Mud |
| 200 | 14 | 15 | 25 | 18 |
| 300 | 20 | 19 | 30 | 17 |
| 400 | 30 | 35 | 32 | 40 |
| 500 | 37 | 37 | 35 | 45 |
| 600 | 35 | 37 | 34 | 46 |
| 700 | 35 | 37 | 30 | |
| 800 | 35 | 35 | 30 | |
| 900 | 35 | 35 | 29 | |
| 1000 | 33 | 31 | 29 | |
| 1100 | 34 | 31 | 28 | |
| 1200 | 35 | 30 | 28 | |
| 1300 | 36 | 30 | 28 | |
| 1400 | 40 | 31 | 28 | |
| 1500 | | 31 | 29 | |
| 1600 | | 34 | 30 | |
| 1700 | | 34 | 30 | |
| 1800 | | 34 | 35 | |
| 1900 | | 35 | 38 | |
| 2000 | | 35 | 43 | |
| 2100 | | 37 | 45 | |
| 2200 | | 39 | 47 | |
| 2300 | | 40 | 49 | |
| 2400 | | 43 | 50 | |
| 2500 | | 44 | 50 | |
| 2600 | | 47 | 53 | |
| 2700 | | 55 | 53 | |
| 2800 | | 60 | 53 | |
| 2900 | | 70 | 54 | |
| 3000 | | | 60 | |
| 3100 | | | | |

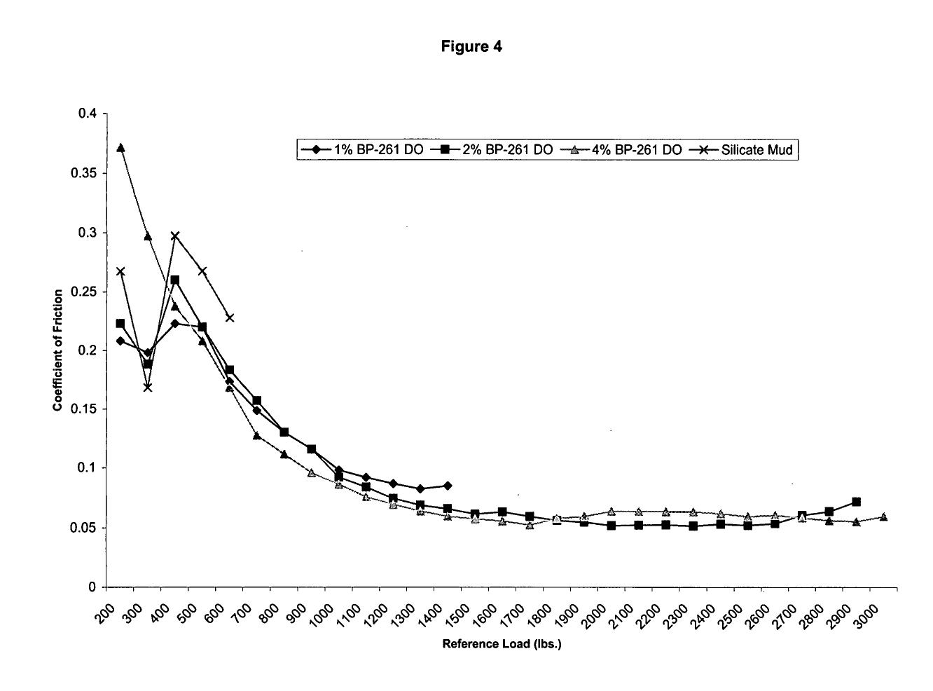

Then, the coefficient of friction was calculated at certain reference loads for the silicate mud, results of which are shown in Table 5 and depicted in FIG. 4. As shown in FIG. 4, each of the samples containing BP261 DO exhibits lower coefficients of friction at higher loads than the silicate mud without any lubricating composition present.

TABLE 5
Coefficient of Friction

| Reference | BP-261 DO | BP-261 DO | BP-261 DO | |
|---|---|---|---|---|
| Load (lbs) | 1% | 2% | 4% | Silicate Mud |
| 200 | 0.2081 | 0.2229 | 0.3716 | 0.2675 |
| 300 | 0.1982 | 0.1883 | 0.2973 | 0.1684 |
| 400 | 0.2229 | 0.2601 | 0.2378 | 0.2973 |
| 500 | 0.2200 | 0.2200 | 0.2081 | 0.2675 |
| 600 | 0.1734 | 0.1833 | 0.1684 | 0.2279 |
| 700 | 0.1486 | 0.1571 | 0.1274 | |
| 800 | 0.1301 | 0.1301 | 0.1115 | |
| 900 | 0.1156 | 0.1156 | 0.0958 | |
| 1000 | 0.0981 | 0.0922 | 0.0862 | |
| 1100 | 0.0919 | 0.0838 | 0.0757 | |
| 1200 | 0.0867 | 0.0743 | 0.0694 | |
| 1300 | 0.0823 | 0.0686 | 0.0640 | |
| 1400 | 0.0849 | 0.0658 | 0.0595 | |
| 1500 | | 0.0614 | 0.0575 | |
| 1600 | | 0.0632 | 0.0557 | |
| 1700 | | 0.0595 | 0.0525 | |
| 1800 | | 0.0561 | 0.0578 | |
| 1900 | | 0.0548 | 0.0595 | |
| 2000 | | 0.0520 | 0.0639 | |
| 2100 | | 0.0524 | 0.0637 | |
| 2200 | | 0.0527 | 0.0635 | |
| 2300 | | 0.0517 | 0.0633 | |
| 2400 | | 0.0533 | 0.0619 | |
| 2500 | | 0.0523 | 0.0595 | |
| 2600 | | 0.0537 | 0.0606 | |
| 2700 | | 0.0606 | 0.0584 | |
| 2800 | | 0.0637 | 0.0563 | |
| 2900 | | 0.0718 | 0.0554 | |
| 3000 | | | 0.0595 | |
| 3100 | | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A lubricating composition for use in a borehole, comprising:
a drilling fluid; and
a diester of an alkyleneoxide polymer.

2. A lubricating composition as in claim 1, wherein said alkyleneoxide polymer has been esterified with a fatty acid, said fatty acid being from about 8 to about 26 carbons in length.

3. A lubricating composition as in claim 1, wherein said alkyleneoxide polymer has been esterified with oleic acid.

4. A lubricating composition as in claim 1, wherein said alkyleneoxide polymer comprises a block co-polymer of ethylene oxide/propylene oxide.

5. A lubricating composition as in claim 4, wherein said block co-polymer of ethylene oxide/propylene oxide comprises from about 5% to about 20% ethylene oxide by weight.

6. A lubricating composition as in claim 4, wherein said block co-polymer of ethylene oxide/propylene oxide is capped by ethylene oxide.

7. A lubricating composition as in claim 1, wherein said alkyleneoxide polymer is homopolymer of polypropylene glycol having at least one monomer of propylene oxide.

8. A lubricating composition as in claim 1, wherein said alkyleneoxide polymer is homopolymer of polyethylene glycol having at least one monomer of ethylene oxide.

9. A lubricating composition as in claim 1, wherein said diester of an alkyleneoxide polymer comprises a dioleate of a block co-polymer of ethylene oxide/propylene oxide.

10. A lubricating composition as in claim 1, wherein the lubricant has a pH value of greater than about 7.

11. A lubricating composition as in claim 1, wherein the lubricant has a pH value of greater than about 9.

12. A lubricating composition as in claim 1, wherein said drilling fluid is a water based drilling fluid.

13. A lubricating composition as in claim 1, wherein said drilling fluid is an oil based or a silicate based drilling fluid.

14. A lubricating composition as in claim 13, wherein the lubricant has a pH value of greater than about 12.

15. A lubricating composition as in claim 1, wherein said diester of an alkyleneoxide polymer is present in an amount from about 0.1% to about 8% by weight.

16. A lubricating composition as in claim 1, wherein said diester of an alkyleneoxide polymer is present in an amount from about 0.5% to about 6% by weight.

17. A lubricating composition as in claim 1, wherein said diester of an alkyleneoxide polymer is present in an amount from about 2% to about 4% by weight.

18. A lubricating composition as in claim 1, wherein said diester of an alkyleneoxide polymer is present in an amount that does not destabilize the drilling fluid.

19. A lubricating composition for use in a borehole, comprising:
a drilling fluid; and
a diester of a block co-polymer of ethylene oxide/propylene oxide.

20. A lubricating composition as in claim 19, wherein said block co-polymer of ethylene oxide/propylene oxide has been diesterified with a fatty acid, said fatty acid having a carbon chain containing from about 8 to about 26 carbons.

21. A lubricating composition as in claim 19, wherein said diester of a block co-polymer of ethylene oxide/propylene oxide is an oleic acid diester of a block co-polymer of ethylene oxide/propylene oxide.

22. A lubricating composition as in claim 19, wherein the lubricant has a pH value of greater than about 7.

23. A lubricating composition as in claim 19, wherein the lubricant has a pH value of greater than about 9.

24. A lubricating composition as in claim 19, wherein said drilling fluid is a water based drilling fluid.

25. A lubricating composition as in claim 19, wherein said drilling fluid is a silicate based or oil based drilling fluid.

26. A lubricating composition as in claim 25, wherein the lubricant has a pH value of greater than about 12.

27. A lubricating composition as in claim 19, wherein said diester block copolymer is present in an amount of about 0.1% to about 8% by weight of the lubricating composition.

28. A lubricating composition for use in a borehole, comprising:
a drilling fluid, said drilling fluid having a pH value of greater than about 7; and
a dioleate block co-polymer of ethylene oxide/propylene oxide, wherein said block co-polymer has an average molecular weight of about 2000 and comprises about 10% ethylene oxide and about 90% propylene oxide, said block co-polymer being capped by ethylene oxide.

29. A method for drilling a borehole or well, comprising:
providing a drill bit;
connecting a drillpipe string to the drill bit;
injecting a drilling fluid into the drillpipe string so that the drilling fluid flows through the drillpipe string to the drill bit, wherein the drilling fluid comprises a diester of an alkyleneoxide polymer.

30. A method for drilling a borehole as in claim 29, wherein the alkyleneoxide polymer is a block co-polymer of ethylene oxide/propylene oxide.

31. A method for drilling a borehole as in claim 29, wherein the alkyleneoxide polymer has been esterified with oleic acid.
